(19) United States
(12) Patent Application Publication
(10) Pub. No.: US 2015/0345448 A1
(43) Pub. Date: Dec. 3, 2015

(54) FLOW LIMITER AND FILTER ASSEMBLY FOR A FUEL SYSTEM OF AN ENGINE

(71) Applicant: Caterpillar Inc., Peoria, IL (US)

(72) Inventors: Michael David Gerstner, Peoria, IL (US); David C. Mack, Peoria, IL (US)

(73) Assignee: Caterpillar Inc., Peoria, IL (US)

(21) Appl. No.: 14/290,375

(22) Filed: May 29, 2014

(51) Int. Cl. F02M 59/44; F02M 61/16; F02M 55/02

(52) U.S. Cl. CPC F02M 59/447; F02M 55/025; F02M 61/165

(57) ABSTRACT

A flow limiter and filter assembly for a fuel system of an engine includes a flow limiting valve attached to a filter element. The filter element has a large area inlet and a screen of small area outlets. Each of a plurality of quills for the fuel system includes a flow limiter and filter assembly positioned in a quill passage in contact with a limiter seat of a quill body, and the filter element is out of contact with the quill body.

### TECHNICAL FIELD

The present disclosure relates generally to fuel systems for engines, and more particularly to a flow limiter and filter assembly associated with each fuel injector of the fuel system.

### BACKGROUND

Common rail fuel systems typically employ multiple fuel injectors to inject highly pressurized fuel into combustion chambers of an engine. The high pressure fuel is supplied to the individual fuel injectors by individual supply lines or quills connected between the common rail and each of the fuel injectors. In some configurations, fuel flow limiters can be employed in the quill to limit the quantity of fuel injected by an individual fuel injector, and limit fuel leakage during potential catastrophic injector failure or to dampen pressure oscillations caused by normal operation of the fuel injectors. Many fuel system also employ edge filters in the quill to prevent small metallic shavings and particles that are produced when an engine is first put into service from reaching and undermining performance in the individual fuel injectors. Co-owned U.S. Pat. No. 8,622,046 shows an example fuel system having both a flow limiter and a separate edge filter positioned in the quill associated with each fuel injector. In some instances, edge filters may let debris pass that is primarily two dimensional in shape. In addition, filters and quills can sometimes migrate to undesirable locations in the quill under certain circumstances.

The present disclosure is directed toward one or more of the problems set forth above.

### SUMMARY

In one aspect, a flow limiter and filter assembly for a fuel system includes a flow limiting valve attached to a filter element at an attachment along a centerline. The filter element defines a large area inlet at the attachment and a screen of small area outlets that extend between an inner surface and an outer surface. The flow limiting valve includes an external quill contact surface and a valve body with an inlet separated from an outlet by an internal valve seat. The flow limiting valve also includes a valve member movable in the valve body along the centerline between an open position out of contact with the valve seat and a closed position in contact with the valve seat. The flow limiting valve also includes a spring operably positioned to bias the valve member toward the open position.

In another aspect, a quill for a fuel system includes a quill body that defines a centerline positioned inside a passage that extends from a first end to a second end. The quill body includes an external surface that includes a spherical seating surface at the second end. The passage includes a step reduction in diameter in a direction from the first end to the second end. The quill body includes a conical seat at the step reduction. A flow limiter and filter assembly is positioned in the passage in contact with the conical seat, and includes a filter element out of contact with the quill body.

In still another aspect, a fuel system for an engine includes a plurality of fuel injectors that are each fluidly connected to a common rail by one quill of a plurality of quills. Each of the quills includes a flow limiter and filter assembly positioned in a quill passage in contact with a conical seat of a quill body. The flow limiter and filter assembly includes a filter element out of contact with the quill body.

### BRIEF DESCRIPTION OF THE DRAWINGS

FIG. 1 is a partial perspective view of an engine and fuel system according to the present disclosure;

FIG. 2 is a sectioned side view of a portion of the fuel system of FIG. 1;

FIG. 3 is an enlarged sectioned side view of a flow limiter and filter assembly from the fuel system of FIGS. 1 and 2; and

FIG. 4 is a sectioned perspective view of a filter element for the flow limiter and filter assembly of FIG. 3.

### DETAILED DESCRIPTION

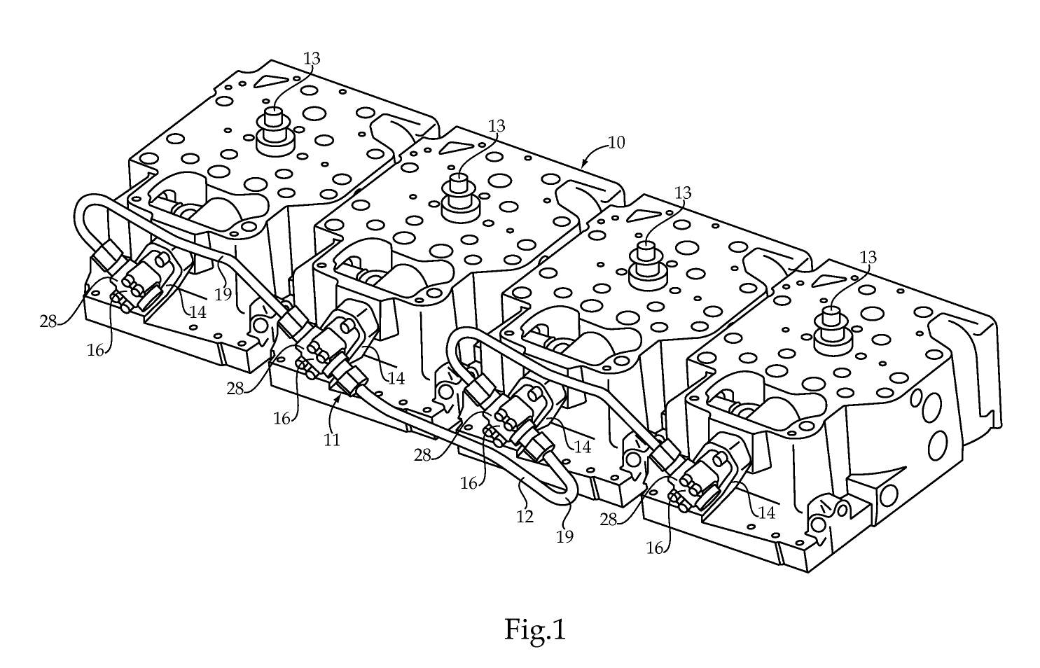

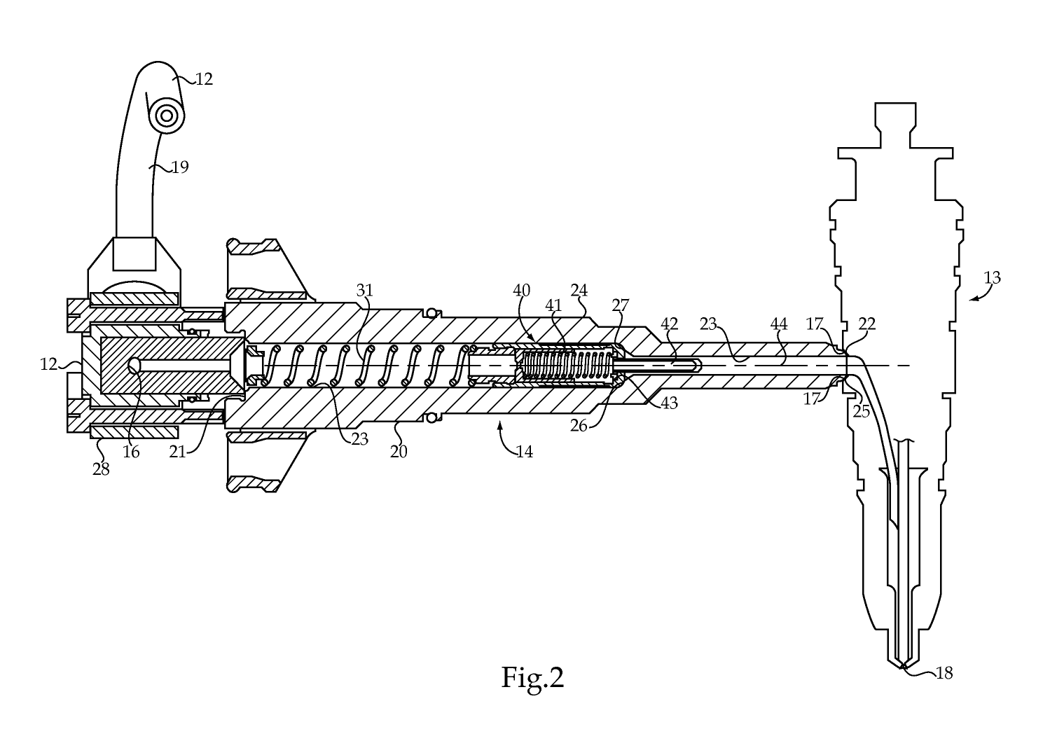

Referring initially to FIGS. 1 and 2, a portion of an engine 10 has part of a fuel system 11 attached thereto. In particular, fuel system 11 includes a common rail 12 and a plurality of fuel injectors 13. Each of the fuel injectors 13 are fluidly connected to the common rail 12 by one quill 14 of a plurality of quills 14. In this example embodiment common rail 12 has a so called daisy chain configuration in which segments of fuel line 19 interconnect individual caps 28 that constitute a segment 16 of common rail 12 and are attached to one end of each of the individual quills 14. Each of the quills 14 includes a quill body 20 that defines a centerline 44 positioned inside of a quill passage 23 that extends from a first end 21 to a second end 22. The quill body 20 also includes an external surface 24 that includes a spherical seating surface 25 at the second end 22 in contact with a conical seat 17 of one fuel injector 13. In particular, the quill 14 may be clamped to engine 10 so that spherical surface 25 is forced into sealing contact with conical seat 17. Fuel supplied from common rail 12 through quill 14 exits fuel injector 13 through a nozzle outlet 18 in a conventional manner.

Each of the quills 14 includes a flow limiter and filter assembly 40 positioned in quill passage 23 in contact with a limiter seat 27 of quill body 20 that may be any suitable shape such as conical or a shoulder. The flow limiter and filter assembly 40 includes a filter element 42 that is out of contact with the quill body 20. Quill passage 23 includes a step reduction in diameter 26 in a direction from first end 21 to second end 22. The seat 27 may be located at the step reduction 26.

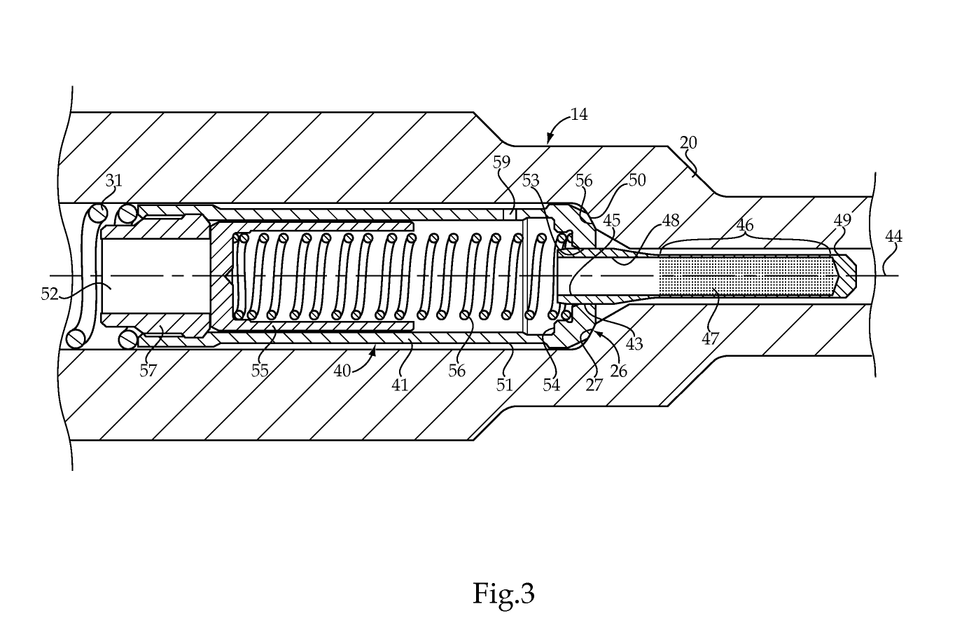

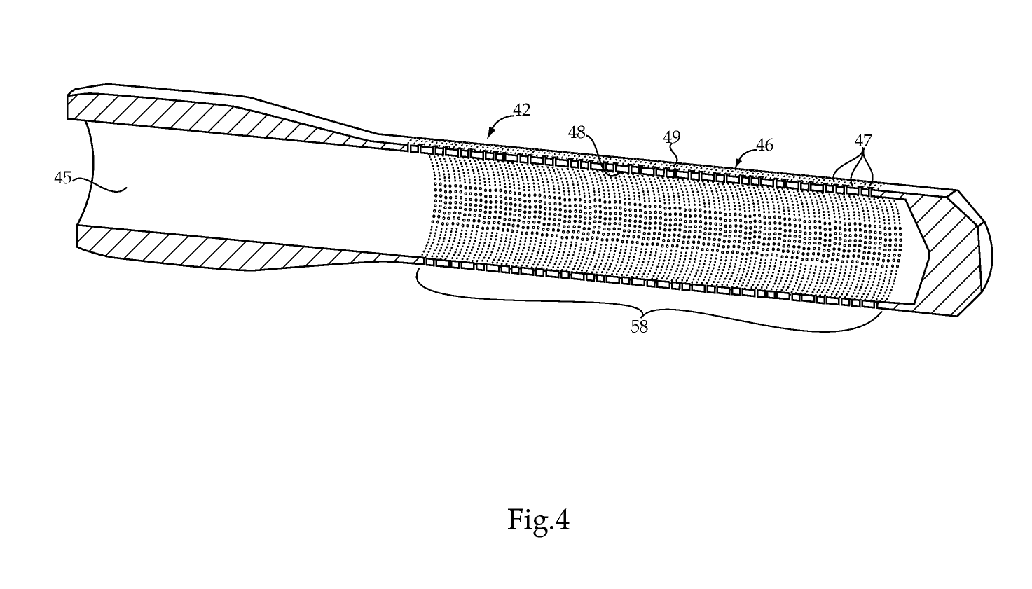

Referring in addition to FIGS. 3 and 4. Each flow limiter and filter assembly 40 includes a flow limiting valve 41 attached to a filter element 42 at an attachment 43 along centerline 44. Although the flow limiter and filter assembly 40 may be mounted in any suitable manner within passage 23, such as via a press fit, the illustrated embodiment, shows flow limiter and filter assembly 40 being pushed into contact with seat 27 of quill body 20 by a spring 31. The filter element 42 defines a large area inlet 45 at the attachment 43 and a screen 46 of small area outlets 47 that extend between an inner surface 48 and an outer surface 49. The structure of filter element 42 is an alternative to known edge filters sometimes used in quills of the prior art. The screen 46 of small area outlets 47 is believed to better prevent two dimensional debris from reaching fuel injector 13, whereas prior art edge filter sometimes allow passage of two dimensional debris toward a fuel injector.

The flow limiting valve 41 includes an external quill contact surface 50, a valve body 51 with an inlet 52 separated from an outlet 53 by an internal valve seat 54. Flow limiting valve 41 also includes a valve member 55 movable in the valve body 51 along centerline 44 between an open position out of contact with the valve seat 54, as shown, and a closed position in contact with the valve seat 54. A reset orifice 59 through valve body 51 allows fuel to flow into flow limiting valve 41 between injection events to that valve member 55 can return to the position shown.

A spring 56 is operably positioned to bias the valve member 55 toward the open position. Although not necessary, the valve body 51 may include the external quill contact surface 50, but other constructions could also fall within the scope of the disclosure. In addition, although not necessary, the screen 46 of small area inlets 47 may have a combined flow area greater than an area of the large area inlet 45 so that some accumulation of debris can occur without creating a substantial flow restriction in passage 23. In the illustrated embodiment, the flow limiter and filter assembly 40 may include a nut 57 threadably attached to valve body 51 to trap valve member 55 between the valve seat 54 and the nut 57. As best shown in FIG. 4, the screen 46 of small area outlets 47 may be located in a cylindrical segment 58 of filter element 42 that is about half a length of the filter element 42 along centerline 44. The term “about half” means that the ratio of segment 58 to the total length of filter element 42 equals one half when rounded to a single significant digit.

### INDUSTRIAL APPLICABILITY

The present disclosure finds potential application to any fuel system that utilizes a flow limiter and a filter to prevent debris carried by fuel from reaching the individual fuel injectors. The present disclosure finds specific applicability to common rail fuel systems that utilize individual quills to fluidly connect the common rail to each fuel injector.

Although not necessary, the filter element 42 of the present disclosure may be press fit attached to the valve body 51 as best shown in FIG. 3. Although not necessary, filter element 42 and/or valve body 51 could include a shoulder surface to insure that filter element 42 stays connected to valve body 51 even if substantial debris collects in filter element 42 resulting in a pressure drop across screen 46 that could tend to urge filter element 42 toward second end 22 of quill body 20. By utilizing a screen 46 of small area outlets 47 instead of an edge filter design, the flow limiter in filter assembly 40 of the present disclosure can better prevent some two dimensional debris that might otherwise pass an edge filter from reaching fuel injector 13. For instance, when an engine is first put into service, initial wear can create small two dimensional metallic debris that gets carried toward individual fuel injectors 13 in the normal fuel flow. It is believed that the filter element 42 of the present disclosure better inhibits passage of this type of two dimensional debris. It is also important to note that unlike edge filters of the prior art that are often press fit into contact with the quill body of their respective fuel system, the filter element 42 of the present disclosure is in contact with the valve body 51 of the flow limiter and valve assembly 40, but is completely out of contact with the quill body 20.

The design of the present disclosure, among other things, helps to insure that the filter element 42 does not migrate or move inside of quill body 20 in the direction of fuel injector 13, which could cause problems. By securely press fitting filter element 42 into valve body 51, and then trapping the flow limiter and filter assembly 40 by the step reduction in diameter 26 within passage 23. Migration of the filter element 40 and/or flow limiter valve 41 is prevented.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A flow limiter and filter assembly for a fuel system, comprising:
a flow limiting valve attached to a filter element at an attachment along a centerline;
the filter element defining a large area inlet at the attachment and a screen of small area outlets that extend between an inner surface and an outer surface; and
the flow limiting valve includes an external quill contact surface, a valve body with an inlet separated from an outlet by an internal valve seat, a valve member movable in the valve body along the centerline between an open position out of contact with the valve seat and a closed position in contact with the valve seat, and a spring operably positioned to bias the valve member toward the open position.

2. The flow limiter and filter assembly of claim 1 including a nut threadably attached to the valve body to trap the valve member between the valve seat and the nut.

3. The flow limiter and filter assembly of claim 2 wherein the valve body includes the external quill contact surface.

4. The flow limiter and filter assembly of claim 3 wherein the screen of small area outlets have a combined flow area greater than an area of the large area inlet.

5. The flow limiter and filter assembly of claim 4 wherein the screen of small area outlets is located in a cylindrical segment of the filter element that is about half a length of the filter element along the centerline.

6. A quill for a fuel system, comprising:
a quill body that defines a centerline positioned inside a passage that extends from a first end to a second end, and an external surface that includes a spherical seating surface at the second end;
the passage including step reduction in diameter in a direction from the first end to the second end;
the quill body includes a limiter seat at the step reduction;
a flow limiter and filter assembly positioned in the passage in contact with the limiter seat, and including a filter element out of contact with the quill body.

7. The quill of claim 6 wherein the flow limiter and filter assembly includes a flow limiting valve attached to the filter element at an attachment along the centerline;
the filter element defining a large area inlet at the attachment and a screen of small area outlets that extend between an inner surface and an outer surface; and
the flow limiting valve includes an external quill contact surface, a valve body with an inlet separated from an outlet by an internal valve seat, a valve member movable in the valve body along the centerline between an open position out of contact with the valve seat and a closed position in contact with the valve seat, and a spring operably positioned to bias the valve member toward the open position.

8. The quill of claim 7 including a nut threadably attached to the valve body to trap the valve member between the valve seat and the nut.

9. The quill of claim 8 wherein the valve body includes the external quill contact surface.

10. The quill of claim 9 wherein the screen of small area outlets has a combined flow area greater than an area of the large area inlet.

11. The quill of claim 10 wherein the screen of small area outlets is located in a cylindrical segment of the filter element that is about half a length of the filter element along the centerline.

12. The quill of claim 11 including a cap attached to the first end of the quill body; and
the cap is a segment of a common rail.

13. The quill of claim 6 including a cap attached to the first end of the quill body;
the cap is a segment of a common rail.

14. A fuel system for an engine, comprising:
a common rail;
a plurality of fuel injectors;
each of the fuel injectors being fluidly connected to the common rail by one quill of a plurality of quills;
each of the quills includes a flow limiter and filter assembly positioned in a quill passage in contact with a limiter seat of a quill body, and including a filter element out of contact with the quill body.

15. The fuel system of claim 14 wherein the quill body defines a centerline positioned inside the quill passage that extends from a first end to a second end, and an external surface that includes a spherical seating surface at the second end in contact with a conical seat of one of the fuel injectors;
the quill passage including step reduction in diameter in a direction from the first end to the second end;
the quill body includes the limiter seat at the step reduction.

16. The fuel system of claim 15 wherein the flow limiter and filter assembly includes a flow limiting valve attached to the filter element at an attachment along the centerline;
the filter element defining a large area inlet at the attachment and a screen of small area outlets that extend between an inner surface and an outer surface; and
the flow limiting valve includes an external quill contact surface, a valve body with an inlet separated from an outlet by an internal valve seat, a valve member movable in the valve body along the centerline between an open position out of contact with the valve seat and a closed position in contact with the valve seat, and a spring operably positioned to bias the valve member toward the open position.

17. The fuel system of claim 16 including a nut threadably attached to the valve body to trap the valve member between the valve seat and the nut.

18. The fuel system of claim 17 wherein the screen of small area outlets has a combined flow area greater than an area of the large area inlet.

19. The fuel system of claim 18 wherein the screen of small area outlets is located in a cylindrical segment of the filter element that is about half a length of the filter element along the common centerline.

20. The fuel system of claim 19 including a cap attached to the first end of the quill body; and
the cap is a segment of the common rail.
